(19) United States
(12) Patent Application Publication
(10) Pub. No.: US 2021/0107736 A1
(43) Pub. Date: Apr. 15, 2021

(54) Garbage Can Retaining Clip Apparatus

(71) Applicant: William Buck, McKinney, TX (US)

(72) Inventor: William Buck, McKinney, TX (US)

(21) Appl. No.: 16/596,929

(22) Filed: Oct. 9, 2019

(51) Int. Cl. B65F 1/14; B65F 1/06

(52) U.S. Cl. CPC B65F 1/1415; B65F 1/06

(57) ABSTRACT

A garbage bag retaining clip apparatus for securing garbage bag excess includes a housing having an open front side separated from an open back side, a top side separated from an open bottom side, and a left side separated from a right side defining a housing inside. A bag gate is flexibly coupled within the housing inside. The bag gate is biased to rest in the pinch position. A plurality of parallel retaining ridges is coupled to the housing. Each of the retaining ridges extends vertically from the right side and the left side within the housing inside. A tab is coupled to the housing. The tab proximal end has a hinge extending between the left side and the right side proximal the top side and the back side. The tab moves between a locked position engaged within the retaining ridges and a released position extending behind the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to retaining clips and more particularly pertains to a new retaining clip for securing garbage bag excess.

### (2) Description of Related Art Including Information Disclosed Under 37 CFR 1.97 and 1.98

The prior art relates to retaining clips.

### BRIEF SUMMARY OF THE INVENTION

An embodiment of the disclosure meets the needs presented above by generally comprising a housing having an open front side separated from an open back side, a top side separated from an open bottom side, and a left side separated from a right side defining a housing inside. A bag gate is flexibly coupled to the left side within the housing inside. The bag gate moves between a pinch position extending to adjacent the right side and a lifted position extending to adjacent the top side. The bag gate is biased to rest in the pinch position. A plurality of parallel retaining ridges is coupled to the housing. Each of the retaining ridges extends vertically from the right side and the left side within the housing inside proximal the back side. A tab is coupled to the housing. The tab proximal end has a hinge extending between the left side and the right side proximal the top side and the back side. The tab moves between a locked position engaged within the retaining ridges and a released position extending behind the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a garbage bag retaining clip apparatus according to an embodiment of the disclosure.

FIG. 2 is a rear elevation view of an embodiment of the disclosure.

FIG. 3 is a side elevation view of an embodiment of the disclosure.

FIG. 4 is a front elevation view of an embodiment of the disclosure.

FIG. 5 is a cross-sectional view of an embodiment of the disclosure.

FIG. 6 is an in-use view of an embodiment of the disclosure.

### DETAILED DESCRIPTION OF THE INVENTION

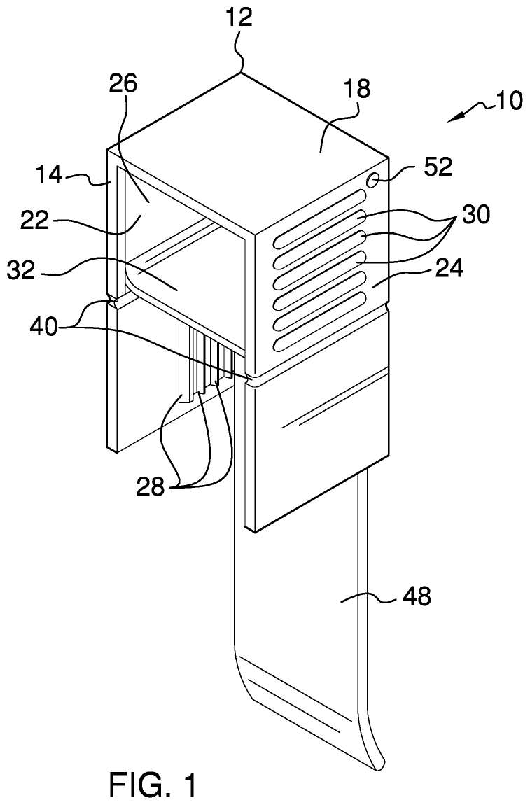

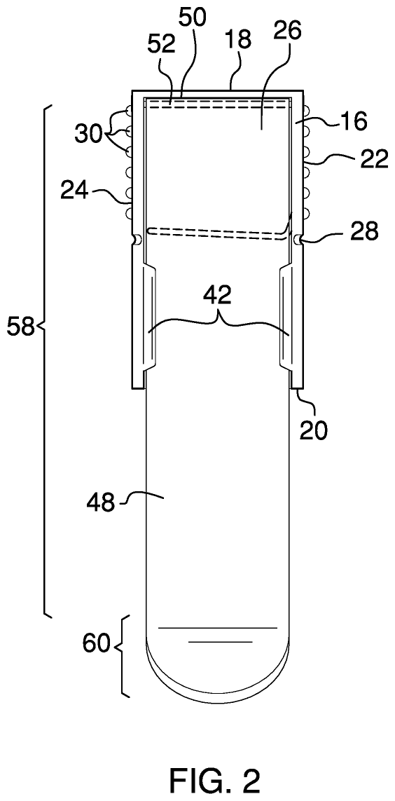

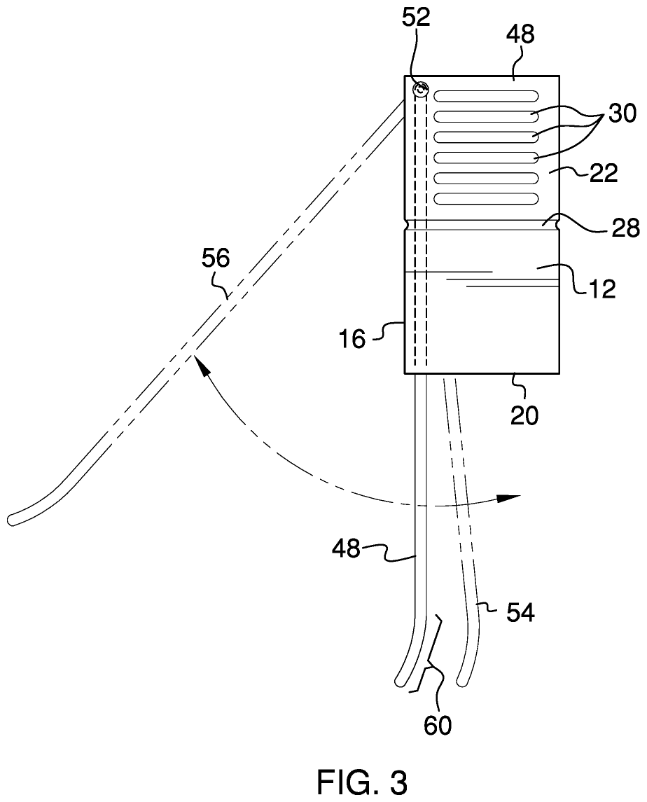

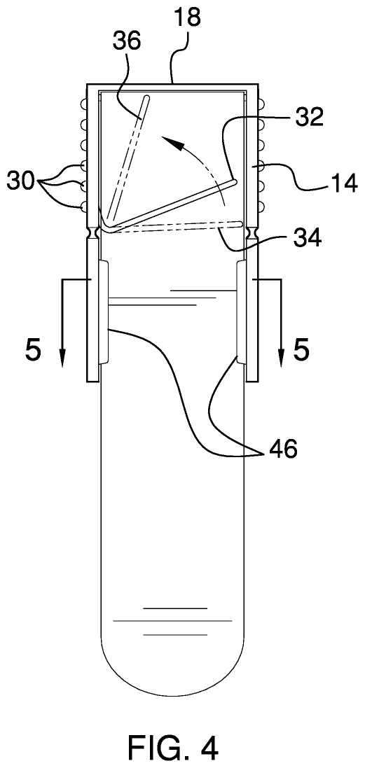

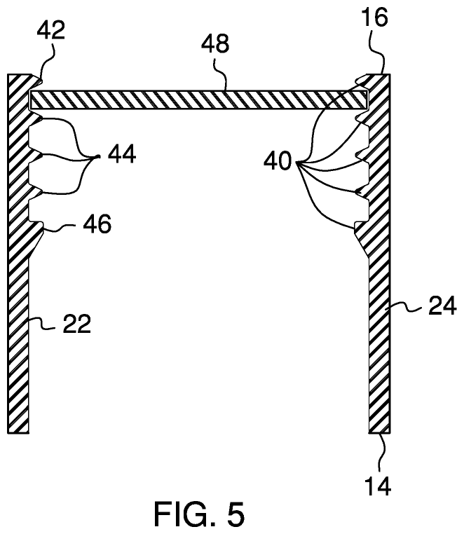

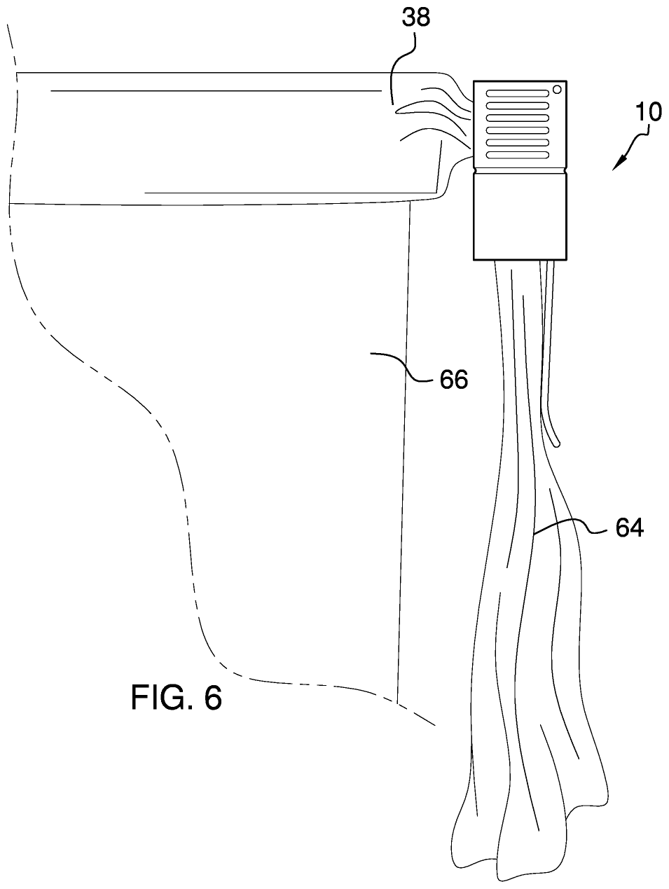

With reference now to the drawings, and in particular to FIGS. 1 through 6 thereof, a new retaining clip embodying the principles and concepts of an embodiment of the disclosure and generally designated by the reference numeral 10 will be described.

As best illustrated in FIGS. 1 through 6, the garbage bag retaining clip apparatus 10 generally comprises a housing 12 having an open front side 14 separated from an open back side 16, a top side 18 separated from an open bottom side 20, and a left side 22 separated from a right side 24 defining a housing inside 26. Each of the left side 22 and the right side 24 having a horizontal medial groove 28 extending from the front side 14 to the back side 16. A plurality of parallel grip ridges 30 may be coupled to the housing 12 to allow a user to more easily secure the apparatus 10. The grip ridges 30 are coupled to the left side 22 and the right side 24 above the medial groove 28. There may be six grip ridges 30 on each of the left side 22 and the right side 24. A bag gate 32 is flexibly coupled to the left side 22 within the housing inside 26. The bag gate 32 moves between a pinch position 34 extending to adjacent the right side 24 and a lifted position 36 extending to adjacent the top side 18. The bag gate 32 is biased to rest in the pinch position 34 and is configured to secure a garbage bag 38 passing through the front side 14 and out the bottom side 20.

A plurality of parallel retaining ridges 40 is coupled to the housing 12. Each of the retaining ridges 40 extends vertically from the right side 24 and the left side 22 within the housing inside 26 proximal the back side 16 and below the medial groove 28. The plurality of retaining ridges 40 may comprise a pair of outermost ridges 42 adjacent the back side 16, a set of three pairs of medial ridges 44, and a pair of innermost ridges 46. Each of the outermost ridges 40 may be trapezoidal. A tab 48 is coupled to the housing 12. The tab 48 has a proximal end 50 having a hinge 52 extending between the left side 22 and the right side 24 proximal the top side 18 and the back side 16. The tab 48 moves between a locked position 54 engaged within the retaining ridges 40 and a released position 56 extending behind the housing 12. The tab 48 has a planar portion 58 extending from the proximal end 50 past the bottom side 20 of the housing and a curved portion 60 extending from the planar portion 58 to a distal end 62. The curved portion 60 may slope away from the housing 12.

In use, an excess portion 64 of the garbage bag is passed through the front side 14 and out the bottom side 20 and pinched in place by the bag gate 32, thus securing the garbage bag 38 tightly on a garbage can 66. To be released the tab 48 is moved to the released position 56 so the bag gate 32 may be moved to the lifted position 36 and the apparatus 10 may be disengaged from the garbage bag 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garbage bag retaining clip apparatus comprising:
a housing, the housing having an open front side separated from an open back side, a top side separated from an open bottom side, and a left side separated from a right side defining a housing inside;
a bag gate coupled to the housing, the bag gate being flexibly coupled to the left side within the housing inside, the bag gate moving between a pinch position extending to adjacent the right side and a lifted position extending to adjacent the top side, the bag gate being biased to rest in the pinch position;
a plurality of parallel retaining ridges coupled to the housing, each of the retaining ridges extending vertically from the right side and the left side within the housing inside proximal the back side; and
a tab coupled to the housing, the tab having a proximal end having a hinge extending between the left side and the right side proximal the top side and the back side, the tab moving between a locked position engaged within the retaining ridges and a released position extending behind the housing.

2. The garbage bag retaining clip apparatus of claim 1 further comprising a plurality of parallel grip ridges coupled to the left side and the right side of the housing.

3. The garbage bag retaining clip apparatus of claim 1 further comprising the tab having a planar portion extending from the proximal end past the bottom side of the housing and a curved portion extending from the planar portion to a distal end.

4. The garbage bag retaining clip apparatus of claim 3 further comprising the curved portion sloping away from the housing.

5. The garbage bag retaining clip apparatus of claim 1 further comprising the plurality of retaining ridges comprising a pair of outermost ridges adjacent the back side, a set of three pairs of medial ridges, and a pair of innermost ridges.

6. The garbage bag retaining clip apparatus of claim 5 further comprising each of the outermost ridges being trapezoidal.

7. The garbage bag retaining clip apparatus of claim 1 further comprising each of the left side and the right side having a horizontal medial groove extending from the front side to the back side.

8. The garbage bag retaining clip apparatus of claim 7 further comprising the plurality of grip ridges being coupled above the medial groove and the plurality of retaining ridges being coupled below the medial groove.

9. A garbage bag retaining clip apparatus comprising:
a housing, the housing having an open front side separated from an open back side, a top side separated from an open bottom side, and a left side separated from a right side defining a housing inside, each of the left side and the right side having a horizontal medial groove extending from the front side to the back side;
a plurality of parallel grip ridges coupled to the housing, the grip ridges being coupled to the left side and the right side above the medial groove;
a bag gate coupled to the housing, the bag gate being flexibly coupled to the left side within the housing inside, the bag gate moving between a pinch position extending to adjacent the right side and a lifted position extending to adjacent the top side, the bag gate being biased to rest in the pinch position;
a plurality of parallel retaining ridges coupled to the housing, each of the retaining ridges extending vertically from the right side and the left side within the housing inside proximal the back side and below the medial groove, the plurality of retaining ridges comprising a pair of outermost ridges adjacent the back side, a set of three pairs of medial ridges, and a pair of innermost ridges, each of the outermost ridges being trapezoidal; and
a tab coupled to the housing, the tab having a proximal end having a hinge extending between the left side and the right side proximal the top side and the back side, the tab moving between a locked position engaged within the retaining ridges and a released position extending behind the housing, the tab having a planar portion extending from the proximal end past the bottom side of the housing and a curved portion extending from the planar portion to a distal end, the curved portion sloping away from the housing.
